(19) United States
(12) Patent Application Publication
(10) Pub. No.: US 2021/0026069 A1
(43) Pub. Date: Jan. 28, 2021

(54) INTEGRATED NEAR-EYE DISPLAY

(71) Applicants: UNIVERSITEIT GENT, Gent (BE); IMEC VZW, Leuven (BE); ZHEJIANG UNIVERSITY, Zhejiang Province (CN)

(72) Inventors: Roeland BAETS, Deinze (BE); Zhechao WANG, Campbell, CA (US); Qing YANG, Zhejiang Province (CN); Xu LIU, Hangzhou (CN); Haifeng LI, Xihu district (CN)

(21) Appl. No.: 16/498,764

(22) PCT Filed: Mar. 30, 2018
(86) PCT No.: PCT/EP2018/058299

§ 371 Date: Sep. 27, 2019

(30) Foreign Application Priority Data
Mar. 31, 2017 (EP) 17164446.1

(51) Int. Cl. G02B 6/12; G02B 27/01; G02F 1/1347

(52) U.S. Cl. CPC G02B 6/12019; G02B 27/0172; G02B 2006/12123; G02B 2006/12142; G02B 2006/12121; G02F 1/13476

(57) ABSTRACT

The display system for 3D light field generation comprises a photonic circuit comprising a plurality of light emitting units, wherein each light emitting unit comprises a light intensity modulator, and the display system comprises a phased liquid crystal array adapted to control the exiting optical angle of light for emission angle steering. The operations of light intensity modulators and the phased liquid crystal array are synchronized when reconstructing a light field of a virtual 3D object viewed by a user's eye.

### FIELD OF THE INVENTION

The invention relates to the field of optical systems. More specifically it relates to 3D light field displays, such as personal displays.

### BACKGROUND OF THE INVENTION

Displays for virtual reality (VR), augmented reality (AR) and mixed reality (MR) are immersive systems that provide an illusion of reality to a user. These displays can be divided in two main subsystems: a 3D display and motion feedback.

The display provides the visual illusion of a 3D object. These systems aim to provide a natural-looking 3D image, which is usually fed directly to a user's eyes. A high-resolution display is a basic requirement to provide realistic imaging. Traditional tridimensional displays give the illusion of volume and distance by simple binocular disparity; however, accommodation-convergence conflict gives visual confusion and fatigue. Producing subconscious accommodation reflex (like adaptation of muscles of pupil and eye lens) reduces accommodation-converge conflict. For example, although a 3D image display can imitate the sense of depth (e.g. by binocular disparity), having the eye focused on a screen at few centimeters from the eye may cause discomfort and fatigue after few minutes of exposure. At least some eye adaptation is required for a natural feeling of focusing at an object according to the illusion of distance produced by the display. Light field 3D displays reduce discomfort and eye fatigue. Light is emitted in a broad solid angle surrounding an object. Vivid 3D scenes can be reproduced with less visual confusion. Traditional liquid crystals (LCs) have limited operation speed, normally around 1 kHz. This is not fast enough for applications in which a reasonable image quality, resolution and feedback speed are required. On the other hand, systems including spatial modulation of multilayered LCs or high-speed projectors are expensive and/or very bulky. High speed projectors need a very high computational power, for example, which reduces portability and/or increases costs.

US patent application US2015/243094 A1 (SCHOWENGERDT BRIAN T[US] ET AL) 27 Aug. 2015 shows several options for mechanical scan of the light fields. For example, mechanical elements such as fiber cantilevers distribute the image along a display, and a set of diffraction elements (mirrors, optoelectronic materials, etc.) scatter the light at different directions. In other examples, diffraction optical elements (e.g. Bragg gratings) are mechanically adaptable. For example, they may be included in elastic materials which can be stretched, they can vary the distance to the eye, or they may vary a Moiré beat pattern between two non-coplanar gratings. Some gratings are electroactive and can be controlled by polarization and control of liquid crystal (LC) droplets dispersed on a polymer. The relaxation time of LC is low, and multilayer liquid crystals are needed. These systems are bulky, expensive and consume a lot of power. Portability is very limited, and the use of mechanical elements increase manufacturing complexity and fragility of the device. An integrated, inexpensive solution is desirable.

US 2017/003507 A1 discloses a display for augmented reality including an array of optical phase arrays for emitting light encoded as four-dimensional light field so as to create an image of a virtual object on the retina. A liquid crystal layer in communication with the optical phase arrays may be used as a phase modulation layer steering beam angle. The latter is implemented in TFT backplane technology alone. Beam angle steering is achieved by nano-antennas operating at a sub-pixel level which increases the design complexity at a pixel level due to additional routing and control elements and results in an energy-per-area overhead.

Most VR display also comprise motion feedback. The motion feedback provides interaction between the 3D object and the user (for example, change of position of an object upon moving the head or actuating a controller). A slight mismatch between the movement of the user's head and the response of the image, or a slow refresh rate of the images may cause, at best, a poor and awkward immersive experience, and at worst, vertigo and virtual reality sickness. This is problem can solved by increasing the refresh rate of the system, which means that, on one hand, the volume of data is even higher than for a 3D display, a high amount of data has to be dealt with, and on the other hand, displays must be fast enough to deal with this high data volume.

### SUMMARY OF THE INVENTION

It is an object of embodiments of the present invention to provide a 3D display system which can be made compact. It is an advantage of at least some embodiments of the present invention that 3D display systems with good resolution can be obtained. It is an advantage of at least some embodiments of the present invention that 3D display systems with good motion feedback can be obtained. It is an advantage of at least some embodiments of the present invention that 3D display systems with a good frame rate can be obtained. It is an advantage of at least some embodiments of the present invention that fast 3D display systems with good light emission angle steering can be obtained. It is an advantage of some embodiments that high angle resolution can be obtained. It is an advantage of at least some embodiments of the present invention that 3D display systems can be obtained combining some and advantageously all of these above-mentioned advantages. It is an advantage of embodiments of the present invention that 3D displays can be made in a relatively inexpensive way.

The present invention relates to display systems for 3D light field generation, comprising a photonic circuit comprising a plurality of light emitting units, each light emitting unit comprising means to modulate light intensity, such as a light intensity modulator, and a phased liquid crystal array adapted for controlling the exiting angles of light emitted by the light emitting units. The phased liquid crystal array thus may be adapted for emission angle steering. In the present invention, at least one processing unit is connectable to the light intensity modulation means and the phased liquid crystal array, and is suitable, e.g. programmed, for synchronizing th operation of the light intensity modulation means and the phased liquid crystal array when reconstructing a light field of a virtual 3D object viewed by a user's eye.

It is an advantage of some embodiments of the present invention that a compact/fully integrated 3D light field generation display system can be obtained. It is an advantage of embodiments of the present invention that high speed modulation of pixel elements of the display system can be obtained, resulting in a high-quality display system with high frame rates. It is an advantage of embodiments of the present invention that no bulky components are required. It is an advantage of embodiments of the present invention that a 3D light field display system can be obtained by tuning each component of the system electronically, with no mechanical light exiting angle steering.

In a preferred embodiment, the photonic circuit including the plurality of light emitting units is a photonic integrated circuit.

It is an advantage of embodiments of the present invention large volumes of data can be handled for 3D light field reconstruction of a 3D object by synchronizing the emission angle steering and the light intensity modulation.

It is an advantage of some embodiments of the present invention that all constituting components, i.e. photonic integrated circuits, phased liquid crystal array, microlens array, can be manufactured in a mass-productive way, with potentially very low cost.

In some embodiments of the present invention, the photonic circuit is a SiN based photonic integrated circuit. The photonic circuit may further comprise modulators, for example SiN modulators. In further embodiments, the SiN modulators comprise deposited layers of at least PZT and/or engineered metamaterials, for enhanced electro-optic phase modulation of visible light.

It is an advantage of some embodiments of the present invention that a high Pockels coefficient is obtained by employing deposited PZT or metamaterials, and fast phase and intensity modulation of the light beams emitted by the light emitting units can be obtained with low power consumption. The light intensity modulation can be performed at high speed. A high speed intensity modulation can result in a high angle resolution (while the light intensity is being modulated, the output angle is being scanned and therefore a higher angle resolution means that the light intensity is changed over a smaller angle, i.e. the light intensity is changed over a small period of time or with a high modulation speed), while the beam steering can be done in a continuous way, reducing the influence of the relatively slow scan speed.

In embodiments of the present invention, the display system furthermore comprises a microlens array between the light emitting units of the photonic circuit and the phased liquid crystal array, for directing light emitted from the light emitting units towards the phased liquid crystal array. In further embodiments, each microlens of the microlens array is associated with a corresponding light emitting unit and suitable for collimating the light emitted from that light emitting unit.

It is an advantage of some embodiments of the present invention that the size of each microlens can be well adapted to the size of its corresponding light emitting unit, which does not comprise the image resolution.

In some embodiments of the present invention, the photonic circuit and the phased liquid crystal array are positioned in parallel planes. In those embodiments comprising a microlens array, the photonic circuit, the microlens array and the phased liquid crystal array are positioned in parallel planes. It is an advantage of those embodiments of the present invention that the system is easy to align.

In some embodiments of the present invention, the display system furthermore comprises an optical lens for redirecting light exiting the phased liquid crystal array, for the purpose of near-eye imaging. In some embodiments, the display system can include a half-transparent mirror for directing the emitted, steered light to the eye, avoiding blocking the normal view of users.

In some embodiments of the present invention, the light emitting units of the photonic circuit comprise on-chip radiation sources, if the photonic circuit is of the integrated kind. On-chip radiation sources may, for example, include integrated laser diodes in each light emitted unit, or bonded semiconductor lasers coupled with waveguides, which distribute light into each light emitted unit.

In some embodiments of the present invention, the light sources integrated in each light emitting unit can be directly intensity-modulated, therefore no external modulators are needed, which reduces the complexity of the whole system.

It is an advantage of some embodiments of the present invention that the light sources can also be integrated within the photonic circuit of the display system, improving overall integration and portability.

In some embodiments of the present invention, the phased liquid crystal array comprises at least two cascaded liquid crystal steering layers. In embodiments of the present invention, each liquid crystal steering layer of the phased liquid crystal array can control the light exiting angle at the phased liquid crystal array in one direction, horizontal and vertical.

It is an advantage of embodiments of the present invention that a high-speed light exiting angle steering suitable for VR displays can be obtained using electronically controlled phased LC arrays.

In some embodiments of the present invention, the phased liquid crystal array is adapted for manipulating the optical phase distribution in the cross-section of the beamlets of light emitted by the plurality of light emitting units and directed towards the phased liquid crystal array. For example, each layer can steer all the sub-beams with the same signal.

In some embodiments of the present invention, the display system is a fully integrated solution for near-eye 3D light field displaying.

It is an advantage of some embodiments of the present invention that a full integration can be obtained, for example by integrating the processing unit within the device, allowing freedom of movements.

Particular and preferred aspects of the invention are set out in the accompanying independent and dependent claims. Features from the dependent claims may be combined with features of the independent claims and with features of other dependent claims as appropriate and not merely as explicitly set out in the claims.

These and other aspects of the invention will be apparent from and elucidated with reference to the embodiment(s) described hereinafter.

### BRIEF DESCRIPTION OF THE DRAWINGS

FIG. 1 illustrates an exemplary 3D display system according to embodiment of the present invention.

FIG. 2 illustrates a first example of integrated light intensity modulation means for a light emitting unit according to embodiments of the present invention.

FIG. 3 illustrates a second example of integrated light intensity modulation means for a light emitting unit according to embodiments of the present invention.

FIG. 4 illustrates a radiation source coupled to light emitting units comprising a modulator according to embodiments of the present invention.

FIG. 5 illustrates an exemplary 3D display system with a half mirror, for AR and MR systems.

The drawings are only schematic and are non-limiting. In the drawings, the size of some of the elements may be exaggerated and not drawn on scale for illustrative purposes.

Any reference signs in the claims shall not be construed as limiting the scope.

In the different drawings, the same reference signs refer to the same or analogous elements.

### DETAILED DESCRIPTION OF ILLUSTRATIVE EMBODIMENTS

The present invention will be described with respect to particular embodiments and with reference to certain drawings, but the invention is not limited thereto but only by the claims. The drawings described are only schematic and are non-limiting. In the drawings, the size of some of the elements may be exaggerated and not drawn on scale for illustrative purposes. The dimensions and the relative dimensions do not correspond to actual reductions to practice of the invention.

Furthermore, the terms first, second and the like in the description and in the claims, are used for distinguishing between similar elements and not necessarily for describing a sequence, either temporally, spatially, in ranking or in any other manner. It is to be understood that the terms so used are interchangeable under appropriate circumstances and that the embodiments of the invention described herein are capable of operation in other sequences than described or illustrated herein.

Moreover, the terms top, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the claims, should not be interpreted as being restricted to the means listed thereafter; it does not exclude other elements or steps. It is thus to be interpreted as specifying the presence of the stated features, integers, steps or components as referred to, but does not preclude the presence or addition of one or more other features, integers, steps or components, or groups thereof. Thus, the scope of the expression “a device comprising means A and B” should not be limited to devices consisting only of components A and B. It means that with respect to the present invention, the only relevant components of the device are A and B.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to one of ordinary skill in the art from this disclosure, in one or more embodiments.

Similarly it should be appreciated that in the description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the detailed description are hereby expressly incorporated into this detailed description, with each claim standing on its own as a separate embodiment of this invention.

Furthermore, while some embodiments described herein include some, but not other features included in other embodiments, combinations of features of different embodiments are meant to be within the scope of the invention, and form different embodiments, as would be understood by those in the art. For example, in the following claims, any of the claimed embodiments can be used in any combination.

In the description provided herein, numerous specific details are set forth. However, it is understood that embodiments of the invention may be practiced without these specific details. In other instances, well-known methods, structures and techniques have not been shown in detail in order not to obscure an understanding of this description.

Virtual reality systems of the present invention are suitable for head-mounted displays, thus low power consumption and robustness are a requirement typical of wearable devices. This must be combined with a good portability, resolution and speed.

The present VR system provides a 3D light field with high speed and high resolution, by combining the high speed and low power consumption of a semiconductor-based light source array with fast steering of the exiting angle of the emitted light. The system combines a 1 liquid crystal arrangement, which does not sacrifice speed, with light modulation.

In a first aspect, the present invention relates to a display system for virtual reality (VR), augmented reality (AR) and mixed reality (MR). The display system comprises light emitting units which can be intensity-modulated, for example with light intensity modulators, and light angle steering means, for example light diffractive means such as a phased liquid crystal (LC) array, to manipulate the emission angles of the light emitted by the light emitting units, which may include a suitable light source. The modulated intensity and the exiting angle of the emitted light beams are combined and synchronized so as to create the illusion of a 3D object or scene when viewed by the user's eye.

The combination of the high speed modulation of the light emitting units (allowing for high amounts of information to be coded in the light field), synchronized with fast angle steering of emitted light at the phased LC array, can provide a fast refresh rate, despite the processing of a very high amount of data. It can also provide high spatial resolution and high angle resolution.

In embodiments of the present invention, the light emitting units are provided in a photonic circuit, for example a photonic integrated circuit.

One or more processing units (e.g. a single microprocessor) control the light emission at the light emitting units, the refresh rate of the image, the means to manipulate the light exiting angle at the phased LC array, etc. The processing unit (e.g. a CPU and/or graphics card) can be external to the display system, and it may connect to and communicate to the display system via wired or wireless signal transmission. However, it is preferably integrated in the device, improving the portability of the system. The processing unit or units can tune each component of the display system electronically, with no need of mechanical light angle steering.

In embodiments of the present invention, the display system comprises a plurality of light emitting units. The light emitting units may be arranged in any suitable way, for example the light emitting units may be classified in colors, and a set of light emitting units of different colors may be grouped so as to form the light emitting part of a unique pixel element of the display system (e.g. a pixel element may comprise one red, one green and one blue light emitting unit, or one red, two green light emitting units and a blue light emitting unit, etc.). In some embodiments, these light emitting units comprise laser sources, for example laser diodes. Each light emitting unit comprises means to provide light intensity modulation, e.g. modulators.

Modulation may be provided by other suitable means. For example, the electric current which energizes a light emitting unit, e.g. a laser, can be controlled, e.g. by a controller or a processing unit. In general, the power source of each light emitting unit can be modulated in a suitable way.

In some embodiments, the light emitting units are integrated on-chip in a semiconductor photonics platform, forming a photonic integrated circuit. A compact 3D light field generation display system can be obtained, which can be fully integrated, for example the display system may integrate also the phased LC array and its controllers, and also other optical elements. Standard well-known semiconductor manufacturing routes can be used, which reduces manufacturing costs.

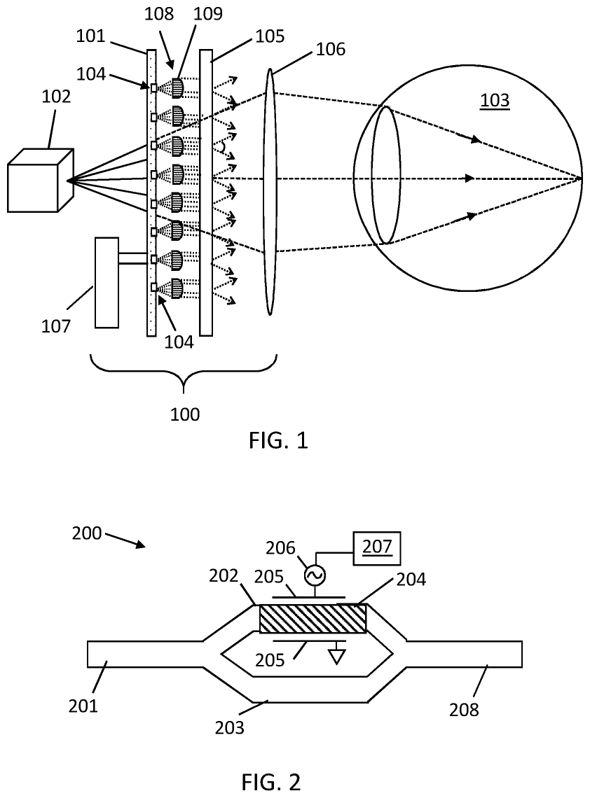

FIG. 1 shows an exemplary embodiment of a display system 100 wherein a photonic circuit 101 is provided as an integrated photonic circuit including an array of light emitting units 104. The display system 100 can recreate a 3D virtual object 102 by creating a virtual image of the object in a subject's eye 103. The light emitting units 104 may comprise radiation sources. In embodiments in which these are on-chip radiation sources, the device can advantageously be compact. A phased LC array 105 receives the modulated light beamlets from the array of light emitting units 104 and steers the exiting angle of the light beamlets, before they travel to the subject's eye 103. A lens 106 may be included, for converging the steered light beamlets from the phased LC array into the eye 103, or it may be external to the display system 100. The use of light emitting units 104 and electronic control (e.g. in integrated systems) allows high speed, which in combination with the synchronized steering of the light exiting angles at the phased LC array 105, results in a display system 100 which can handle fast frame rates conveying large volumes of data. The control and synchronization of the light emitting units 104 and of the phased LC array 105 is performed with a processing unit 107. Synchronization may, for example, be obtained by adapting the processing unit 107 for sending an update signal to the phased LC array 105 for updating the exiting angles at a rate which is an entire multiple of a rate at which the light intensity values of light emitting units 104 are updated.

Further optic elements can be used, such as further lenses. In some embodiments, a microlens array 108 may send and direct the light beamlets from the light emitting units 104 to the phased LC array 105. For example, each microlens 109 of the array may be coupled to one or more corresponding light emitting units 104, ensuring efficient collimation of light. In some embodiments, each microlens array 108 collimates the light from exactly one corresponding light emitting unit 104, before directing it to the phased LC array. This results in a homogeneous wave front. The size of the microlenses 109 can be adapted to the size of the one or more corresponding light emitting units 104, in order to avoid deteriorating the image resolution.

In embodiments of the present invention, the array of light emitting units 104 may be laid out parallel to the phased LC array 105. For example, the photonic circuit 101 may be parallel to the phased LC array 105. The microlens array 108 may also be parallel to them. The general layout, however, does not have to be flat. For example, an array of light emitting units 104 and the phased LC array 105 may have the shape of a dome.

In what follows, the provision of light and light intensity modulation will be first explained, using for example laser sources (although the present invention is not limited to these) and electronic modulation. Then, light exiting angle steering at the phased LC array 105 will be explained.

Radiation sources may be comprised in the photonic circuit 101 and, if the photonic circuit 101 is of the integrated kind, may also be integrated therein. An example of on-chip radiation sources may include integrated laser sources whose output is coupled, via any suitable waveguide or waveguides, to the light emitting units 104. For example, laser sources of different colors (for example three sources of different colors, such as RGB) may be provided on-chip, for example by flip-chip technology, by bonding, etc. and the laser outputs may be coupled to the light emitting units 104 via bus waveguides. However, the present invention may comprise other methods of providing light to the display system 100, such as off-chip lasers, or by providing a tunable laser (e.g. microlasers) as a light emitting unit 104.

As already mentioned, the light emitting units 104 can be modulated directly with no additional external modulator, for example by simply controlling the input electrical current which drives the light emitting unit 104. Alternatively, or additionally, external light modulators can be used. In these embodiments, the photonic circuit 101 of the integrated kind may comprise integrated modulators comprising any suitable optical material, allowing light intensity modulation in each light emitting unit 104. In some embodiments of the present invention, modulators comprising SiN can be used. In preferred embodiments, the photonic circuit 101 is a photonic integrated circuit and comprises high-speed modulator materials that require low power consumption. Modulators comprising SiN (SiN modulators) can easily be integrated in SiN-based photonic integrated circuits. In some embodiments of the present invention, SiN modulators further comprise engineered metamaterials. These may be provided in layers by deposition (e.g. by atomic layer deposition ALD). Alternatively, or additionally, lead-zirconate-titanate (PZT) materials may be provided (e.g. deposited) on the modulator. The electro-optic effect used for modulation of visible light, for example intensity and/or phase modulation, is enhanced with these new materials, and the modulator power consumption is small. SiN modulators comprising PZT (and/or other metamaterials) present a high Pockels effect (e.g. between 110 to 240 pm/V, for example), which contributes greatly to reduction of power consumption. This can allow operation speeds within the order of tens of GHz (e.g. at least a few hundred kHz to few MHz, e.g. 10 MHz) combined with a consumption down to nanowatts.

The SiN modulator can be implemented in an interferometer, resonators, etc., allowing control of intensity and/or phase. An exemplary implementation in a Mach-Zehnder interferometer (WI) can be obtained by splitting the light beam from a source (e.g. an on-chip laser source) in two beams travelling in two different arms, as shown in the modulator 200 of FIG. 2. The MZI may be implemented in a SiN substrate, for example in any suitable waveguide, such as rib waveguides, strip-loaded or ridge waveguides, etc. In order to enhance electro-optical modulation strength and other effects, high confinement can be provided. For example, slot waveguides can be used, and the slot may comprise (e.g. be filled by) electro-optical materials.

The light from the source enters the interferometer through a waveguide input 201 and is divided in two arms 202, 203. On top of a first arm 202, one or more materials 204 with high Pockels coefficients are deposited. Examples of such materials are PZT, or metamaterials consisted of interleaved, two or more different materials such as layered arrangements of the sequence TiO2—Al2O3—In2O3, or a combination thereof. The light beam inside the arm 202 will be at least partially coupled, e.g. fully coupled, into the high Pockels coefficient material 204 on top. The interferometer can be considered as a hybrid SiN phase modulator. Modulation is obtained by applying an electric field on the high Pockels coefficient material 204 (or on the whole first arm 202). The electric field can be applied at electrodes 205, which are shown as lateral electrodes in FIG. 2, but may have other configurations, such as a top electrode, a bottom electrode, etc. It is advantageous that a semiconductor platform can easily provide such electronic components in an integrated way.

The strength can be controlled by any suitable means, e.g. a voltage source 206 and a controller 207, which may be the same as the processing unit 107, or part thereof. By changing the strength of the electric field that is applied at electrodes 205, the strength of the electrical field applied to the high Pockels coefficient material 204 changes, and the optical phase of light travelling in that particular arm can be modulated to carry on information. When the first and second arms 202, 203 are re-combined, the phase modulation performed in the first arm 202 is converted into optical intensity modulation and the modulated light can be sent, via the waveguide output 208, to a light emitting unit 104.

Such implementation presents a power consumption which is orders of magnitude lower than implementations using for example existing thermo-optic modulators, which improves portability and allows the display system 100 to be implemented as a wearable device.

An MZI modulator may advantageously present large optical bandwidth, so it can be advantageously combined with light sources other than lasers.

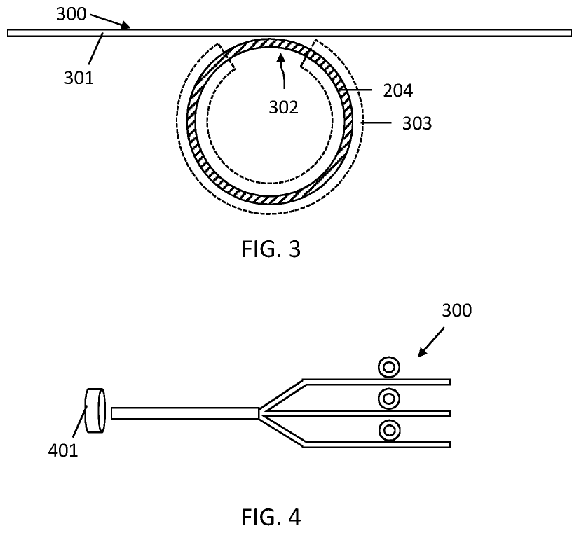

The present invention is not confined to WI-based modulators, and other light intensity modulation means can be used. For example, a ring resonator can be used as a modulator. FIG. 3 shows such a ring resonator-based modulator 300, in which a waveguide 301 carries a light signal from a laser source and a ring resonator 302 is optically coupled to the waveguide 301. The ring resonator 302, comprises one or more high-Pockels coefficient materials 204 on top, for example provided by deposition. When the light signal enters the resonator, it is at least partially coupled into the material 204. By applying an electrical field (e.g. at a top electrode, e.g. a shaped electrode 303), the refractive index of the one or more high-Pockels coefficient materials 204 of the ring resonator 302 changes, leading to a shift in the resonant wavelength. Changes in the resonant wavelength of the ring resonator 302 will lead to a variation of the output light intensity of the waveguide 301. Because the wavelength of the light signal is fixed for a laser source, the light intensity will change as a function of the offset between the laser source wavelength and the resonant wavelength. The latter can be modulated by modulating the strength of the applied electric field. For example, the intensity will be on/off when the laser source wavelength is off/on the modulated resonant wavelength, respectively.

Other configurations can be applied in modulators of the present invention. For example, two arms may comprise PZT and/or metamaterials, but the electric field is introduced in only one of the arms (via an electrode). Alternatively, photonic crystal-based modulators can be used, such as two-dimensional photonic crystals known in the art which, upon electronic actuation, are capable to modulate light passing through them. Any known configuration in the art can be used, for example by providing, in each arm of a MZI modulator, a portion of light guiding photonic crystal structure comprising, e.g., Si (or other suitable material) comprising micro-holes, or other suitable microstructures. Modulation would be provided by applying an electric field in one of the portions of light guiding photonic crystal structure. Thus, the present invention is not limited to modulators comprising PZT and/or other metamaterials.

The advantages of using PZT or metamaterials for the modulators is that these materials can be deposited on top of a photonics platform (e.g. comprising SiN waveguides) in a mass-productive way with low cost. They are characterized by a very large Pockels coefficient, that is a strong, linear electro-optical coupling strength, the effect of which is typically much greater in magnitude compared to the effect which is based on its photo-elastic properties for example. The latter may be used to cause a stress-induced refractive index change in or surrounding the PZT or metamaterial layer, for example in a waveguiding material.

One of the advantages of using ring resonator-based modulators is their very small footprint. Although their optical bandwidth is limited compared to other interferometer-based modulators, this does not affect the intensity modulated light output as long as sufficiently narrow band laser sources are used.

FIG. 4 shows an example of a light emitting units 104 comprising a radiation source 401 (for example an on-chip laser) which provides a source light beam to all of them. Each one of the light emitting units 104 comprises a ring resonator-based modulator 300.

After presenting examples of provision of light and light intensity modulation, light exiting angle steering at the phased LC array will be presented in the following. The present invention provides a system in which the control of light intensity can be performed in synergy with the control of the light exiting angles, in order to reconstruct the 3D light field of a virtual object.

The angle steering can be done by mechanical or non-mechanical means. Non mechanical angle steering means are preferred in the field of wearables, because the angle steering means (e.g. the parameters of the grating) can be electronically controlled. Liquid crystal display technology is well suited, because it can be controlled electronically to periodically change the orientation of the director of the liquid crystal across the liquid crystal layer, thereby inducing a phased polarization grating for an incident, circularly polarized light beamlet which allows achieving large steering angles. Alternatively, for a linearly polarized incident light beamlet, the director orientation can be spatially modulated across the liquid crystal layer such that a periodic phase grating can be achieved. The angle steering can be, for example, ±1.5°, which can be easily achieved. Liquid crystals can be fabricated using well established techniques. They can show high birefringence and can provide large optical path differences using relatively low voltages. In some embodiments of the present invention, the phased liquid crystal (LC) array comprises polarization portions of varying polarization. The light (e.g. the laser beam) can be scanned with a large angle, so the display system can be placed sufficiently far away from the eyes, giving a natural feeling and reducing eye fatigue. It also can be used without blocking the normal view of users, for example for augmented or mixed reality applications.

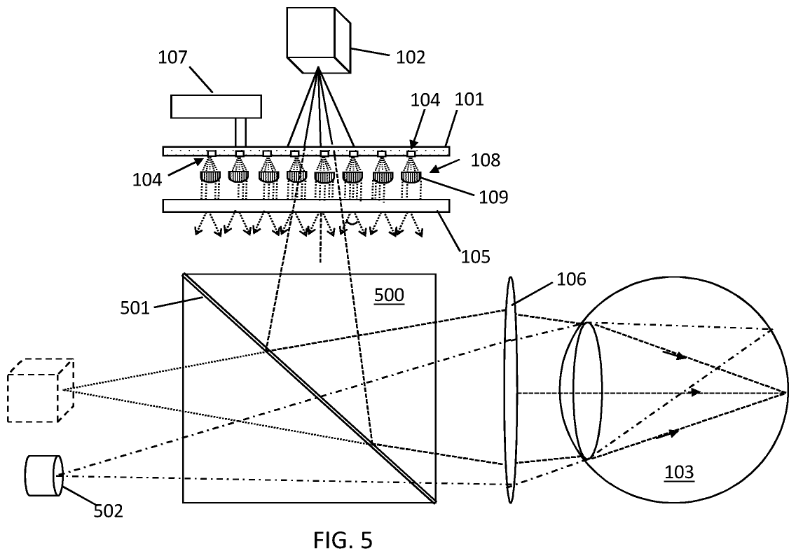

Another alternative way to place the display system 100 such that it does not block the normal view of users is shown in FIG. 5, wherein light is directed from the light emitting units 104 to the eye 103 by reflection with a reflection system 500, for example comprising a half transparent mirror 501, or pellicle mirror (which splits the light without observable double image), etc., which allows directing the virtual images superimposed to the view of the real world such as a real object 502. Such an arrangement can be readily applied to AR and MR systems. The reflection system 500 may comprise and/or be combined with further optical systems, such as further lenses.

The time necessary for steering the light exiting angles at the phased LC array is typically on the order of milliseconds, which implies a light exiting angle steering frequency of 1 kHz or lower. The emission angle of each unit will be tuned by each LC unit separately. The LC has enough bandwidth to provide high update rates for the human eyes, e.g. 30 Hz or 60 Hz. Within each time frame, the light modulation speed determines the spatial resolution. In order to overcome the limited speed of light exiting angle steering at the phased LC array, the phased LC array may comprise multiple layers which can be spatially modulated. However, these solutions are expensive.

The number of stacked steering layers within the phased LC array limits the overall efficiency due to other factors such as scatter or absorption. In embodiments of the present invention, two or more cascaded LC steering layers can be used in the phased LC array. For example, the display system may comprise two cascaded LC steering layers included in the phased LC array, for example stacked on top of each other and having a different angle steering, e.g. different angle steering ranges or resolutions.

In some embodiments, each LC steering layer provides angle steering in one direction, thus obtaining light exiting angle steering in two dimensions at the phased LC array including two LC steering layers.

For example, the phased LC array may comprise two cascaded LC steering layers with different operation speeds each. The first layer may be operated at 30 Hz and the second layer at 1 kHz. However, these values are not limiting.

Any phased LC array can be used. In some embodiments, phased LCs arrays comprise liquid crystal polarization gratings (LCGP). In some embodiments of the present invention, the phased LC array is formed by LC cells which can steer the light exiting angles by manipulating the optical phase distribution in the cross-section of the received light beams.

When the display system is in use, the intensity of the light is electronically modulated, by controlling means such as a processing unit, in each light emitting unit, each of which produces a sub-beam or light beamlet. This light intensity modulation can be done directly on the radiation sources that are included in each of the light emitting units, e.g. by controlling the current that powers them, or can be done via external modulators included in the light emitting units. The output of the light emitting units is directed towards a phased LC array, such as a cascaded phased LC array (optionally after collimation, e.g. with a microlens array) that can manipulate the optical phase distribution in the cross section of each of the beamlets incident thereon.

The optical phase distribution across the beamlets may in one example be controlled by a refractive index gradient forced across a portion of the phased LC array, e.g. by applying a voltage gradient to the electrode structures in this portion of the phased LC array, whereby the directors of the liquid crystal are re-oriented accordingly. Suitable electrode structures for the purpose of applying voltage gradients may comprise a bottom electrode and series of top electrodes, or may comprise a resistive top electrode for which a resistance extending between two points of the electrode causes a linear voltage drop. A processing unit is suited for determining and delivering the voltage gradient signals to the respective portions of the phased LC array. Alternatively, the light exiting angles of beamlets are steered at the phased LC array by locally adapting a grating period of the LC polarization grating, or by locally or globally switching on or off the action of an LC polarization grating by way of re-aligning the LC directors. This can be repeated in a similar fashion for the remaining LC steering layers of the LC steering layer stack, if any. Thus every single pixel element of the display system is adapted for modulating the light intensity of a light beamlet, or light beamlets of different colors in a multicolored display system, as well as controlling its emission direction by steering the light exiting angle at the phased LC array in a synchronized way. The updating of light beamlet intensities or exiting angles of the different pixel elements of the display system can be performed in a synchronized, e.g. parallel, fashion too. However, the intensity of a light beamlet and its exiting angle are in general individually selectable for each and every pixel element. It is an advantage of embodiments of the invention, that only a single light emitting unit, emitting for example a single beamlet, is required per pixel element of the display system. As a result, a denser pixel element array can be designed for the display system, improving image quality and decreasing the complexity and power requirements of control electronics. Moreover, a single light emitting unit can be made larger in lateral dimensions in this case which may, advantageously, decrease the divergence angle of an emitted light beamlet without the need for further collimating optics, e.g. microlens array, etc. This is also beneficial for the light exiting angle steering at the phased LC array, since a not to large and diverging entrance angle of the light beamlets is typically necessary for a good functioning. However, in other embodiments of the invention, it is not excluded that such a microlens array is compactly placed in between the photonic circuit and the phased LC array without compromising the 3D light field creation and better collimation of light emitted by the light emitting units may positively increase the image brightness by reducing optical losses.

In some embodiments of the present invention, all the portions of the phased LC array, each configured to steer the light exiting angle of one particular beamlet, can be driven in unison, e.g. such that they all steer the light exiting angles of the beamlets simultaneously to the same direction. Therefore, all these portions of the phased LC array can be advantageously controlled, for each LC steering layer, by the same signal, thus reducing processing power and complexity of the phased LC array. For example, it is possible to apply a unique phase grating across the entire phased LC array such that portions thereof are having the same phase grating period, strength, and profile, but have a number of grating periods which is less than the total amount. For a simultaneous light exiting angle scan in this case, the processing unit can be configured to uniformly change the grating period or profile of the phase grating which is applied across the entire phased LC array.

Intensity modulation and light exiting angle steering means are synchronized by the processing unit in order to recreate a 3D light field. For example, an algorithm may be provided in the processing unit, or it may be programmed to control at least the light intensity modulation and the light exiting angle steering according to image data and focus data.

In practice the following control could be used for example: Regarding the synchronization of two LC layers, in one exemplary embodiment, the process unit sends repeating control signals of a first frequency, e.g. 30 Hz, to one layer, which will uniformly scan from left to right. In the meantime, the process unit will send control signal of a second frequency, e.g. 900 Hz, to the other LC layer, which will steer the light vertically. Since the vertical scan is much faster than the horizontal scan, for each horizontal scan, the vertical scan will be repeated 30 times. The trajectory of the emitting light will be in the shape of a zigzag, covering the full two-dimensional angle space of, for example 3 degrees by 3 degrees.

Meanwhile, the process unit will process the 3D image to be delivered and get the light intensity information at each output angle of individual pixel. According to the trajectory of the emission angle, the process unit will feed control signals to each pixel and modulate the light intensity, which matches the output angle.

The present invention provides fast 2D angle scan, by phased LC arrays, and intensity modulation in a display system with a large amount of light emitting units, which can be obtained in a photonics platform which can advantageously be integrated. By way of illustration, in one example each pixel can contain 3 light emitting units for generating three basic colors. In the case of using directly modulated nano light sources, the pixel size can be very small, e.g. 10 μm×10 μm. Considering for example a die size of 3 cm by 3 cm, the resolution can be about 3000×3000. If for example on-chip modulators are used to modulate CW light injected by external sources, the size of each pixel is large since the modulators typically are large. Ring resonator based modulators for example are typically in the size of tens of microns by tens of microns (case of SiN platform). The size of a single pixel will then be about 100 μm by 100 μm resulting in a number of pixels of about 300×300 for a same die size. Using electrical absorption modulators can help reducing the pixel size and it is expected that the number of pixels could thus be doubled or tripled. The large volume of data that can be delivered improves the 3D image quality considerably. The angle resolution is determined by the speed of light modulation, so the synchronization of emission angle steering in the LC array (e.g. 3°) with the high-speed intensity modulation allows for a reconstruction of the light field of a 3D virtual object. In one example, the frame update rate (or rendering time) is limited by the LC time constant. The highest LC update rate is about 1 kHz. In order to achieve 30 Hz frame update rate (horizontal scan rate), the horizontal angle resolution may e.g. be 333. The vertical angle resolution is determing by the light modulation speed BW as (1/1 kHz)/(1/BW). This can be obtained in a fully integrated circuit. In some embodiments, the light sources may be external sources (off-chip) and their emitted light may be distributed, via light carriers (e.g. optical fiber and/or waveguides), into the photonic circuit comprising the light emitting units, e.g. an integrated SiN photonic circuit including an array of light emitting units in which the light intensity is modulated by electro-optical modulation means. Light intensity modulation and light exiting angle steering would be both performed electro-optically.

Because of the compact components, embodiments of the present invention provide a portable display system, for example suitable for a head-mounted display, with low power consumption, which can be fast and can be inexpensively manufactured. Additionally, given the broad optical bandwidth of the light intensity modulation means in some embodiments, the display system can be operated with incoherent light which avoids the more difficult to achieve coherence control if laser light sources are used which have long enough coherence lengths to disturb the virtual image formation through interference effects.

The proposed solution is very compact, e.g. a flat 2D screen in a size of 1 cm by 1 cm. In addition, thanks to the photonics technology, mass production and low cost can be expected. A photonic integrated circuit may be co-integrated with the control electronics, e.g. the processing unit, signal wires, or other electronic (logic) devices, the control electronics being fabricated, for example, in a TFT backplane technology, or in a CMOS platform. This light field 3D technology can be applied to virtual/augmented reality applications, medical imaging, TV, movie, mobile phones, automobiles, etc.

1.-13. (canceled)

14. A display system for 3D light field generation, the display system comprising:
a photonic circuit comprising a plurality of light emitting units, each light emitting unit comprising light intensity modulating means for light intensity modulation, and
a phased liquid crystal array adapted to control exiting angles of light emitted by the plurality of light emitting units,
at least one processing unit connectable to the light intensity modulator and the phased liquid crystal array and suitable for synchronizing their operation when reconstructing a light field encoding a virtual 3D object viewed by a user's eye.

15. The display system according to claim 14, wherein the photonic circuit is a photonic integrated circuit.

16. The display system according to claim 15, wherein the photonic integrated circuit is a silicon nitride-based photonic integrated circuit.

17. The display system according to claim 14, wherein the modulating means of the photonic circuit comprises modulators.

18. The display system according to claim 17, wherein the modulators comprise silicon nitride modulators comprising deposited layers of at least PZT and/or engineered metamaterials for enhanced electro-optic phase modulation of visible light.

19. The display system according to claim 14, wherein the system furthermore comprises a microlens array arranged between the light emitting units and the phased liquid crystal array, for directing light emitted from the light emitting units towards the phased liquid crystal array.

20. The display system of claim 19, wherein each microlens of the microlens array is associated with a corresponding light emitting unit and suitable for collimating the light emitted from that light emitting unit.

21. The display system according to claim 14, wherein the photonic circuit and the phased liquid crystal array are positioned in parallel planes.

22. The display system according to claim 19, wherein the photonic circuit, the microlens array and the phased liquid crystal array are positioned in parallel planes.

23. The display system according to claim 14, wherein the display system furthermore comprises an optical lens for redirecting light exiting the phased liquid crystal array for the purpose of near-eye imaging.

24. The display system according to claim 15, wherein the light emitting units comprise on-chip radiation sources, such as, for example, integrated laser diodes in each light emitted unit, or bonded semiconductor lasers coupled with waveguides which distribute light into each light emitted unit.

25. The display system according to claim 14, wherein the phased liquid crystal array comprises at least two cascaded liquid crystal steering layers.

26. The display system according to claim 14, the display system being a fully integrated solution for near-eye 3D light field displaying.
